(19) United States
(12) Patent Application Publication
(10) Pub. No.: US 2026/0354381 A1
(43) Pub. Date: Nov. 12, 2026

(54) AQUEOUS SUSPENSION CONCENTRATE FORMULATIONS OF AGROCHEMICAL ACTIVES

(71) Applicant: BASF AGROCHEMICAL PRODUCTS B.V., Arnhem (NL)

(72) Inventors: Claude Taranta, Limburgerhof (DE); Katja Marxer, Limburgerhof (DE); Simon Nord, Limburgerhof (DE); Steven Joseph Bowe, Durham, NC (US); Sanjeev Kumar Bangarwa, Research Triangle Park, NC (US); Ronald Repage, Durham, NC (US); Ryan Nielson, Durham, NC (US)

(21) Appl. No.: 19/129,038

(22) PCT Filed: Nov. 14, 2023
(86) PCT No.: PCT/EP2023/081719

§ 371 Date: May 12, 2025

(30) Foreign Application Priority Data
Nov. 15, 2022 (EP) 22207502.0

(51) Int. Cl. A01N 43/80; A01N 25/04; A01N 25/22; A01N 25/30; A01N 35/10; A01N 37/40; A01P 13/02

(52) U.S. Cl. CPC A01N 43/80; A01N 25/04; A01N 25/22; A01N 25/30; A01N 35/10; A01N 37/40; A01P 13/02

(57) ABSTRACT

The invention relates to aqueous agrochemical suspension concentrate formulations which comprise a) from 1 to 30 wt %, based on the total weight of the agrochemical suspension concentrate formulation, of at least one first agrochemical active compound, in particular pyroxasulfone, in the form of particles suspended in an aqueous phase (component a); b) 5 to 75 wt %, based on the total weight of the agrochemical suspension concentrate formulation, of at least one second agrochemical active compound, in particular a salt of dicamba or a salt of an imidazolinone herbicide, which is dissolved in the aqueous phase (component b); c) a thickener system (component c) comprising c.1) xanthan gum, c.2) guar gum and c.3) a cellulose-based thickener, d) an aqueous phase comprising water (component d). The invention also relates to the production of the aqueous agrochemical suspension concentrate formulations of the present invention, to the use of the aqueous agrochemical suspension concentrate formulation of the present invention in agriculture and to a method for controlling undesired vegetation and/or plant pathogenic organisms, such as plant pathogenic fungi or invertebrate pests, and/or for regulating the growth of plants, where an agrochemical suspension concentrate formulation of the present invention is allowed to act on the respective pests, their environment, the crop plants to be protected from the respective pest, the plant propagation material of the crop plants and/or the environment of the crop plants.

The present invention relates to an aqueous agrochemical suspension concentrate formulation comprising
a) 1 to 40 wt %, in particular 2 to 35 wt %, preferably 5 to 30 wt %, especially 7 to 28 wt %, based on the total weight of the agrochemical suspension concentrate formulation, of at least one first agrochemical active compound, in particular pyroxasulfone, in the form of particles suspended in an aqueous phase;
b) 5 to 75 wt %, in particular 10 to 70 wt %, preferably 12 to 65 wt %, especially 15 to 60 wt %, based on the total weight of the agrochemical suspension concentrate formulation, of at least one second agrochemical active compound, in particular a salt of dicamba and/or a salt of an imidazolinone herbicide, which is dissolved in the aqueous phase.

The present invention also relates to a process for producing the aqueous agrochemical suspension concentrate formulation and to the use thereof in agriculture.

Concentrated agrochemical formulations are advantageous for the applicant since the volume and weight of the concentrates can be significantly reduced. The concentrated agrochemical products may be formulated in different ways depending on the physiochemical properties of the agrochemical active compounds contained therein. Agrochemical active compounds having a limited solubility in water are often formulated as wettable powders (WP) or granules (WG), as emulsifiable concentrates (EC), as emulsions (EW), as suspoemulsions (SE), as microemulsions (ME) or as aqueous suspension concentrates (SC). Agrochemical active compounds having a good solubility in water are frequently formulated as soluble liquids.

For water-insoluble agricultural actives the formulation as an aqueous suspension concentrate (SC) formulation is highly desirable because SC formulations do not require high amounts of organic solvents. Moreover, they can be easily prepared by milling the agricultural active in an aqueous medium. On the other hand, SC formulations are thermodynamically instable and tend to agglomeration of the agricultural active, sedimentation and caking, which is pronounced at high concentrations of the agrochemical active compound. The presence of high concentrations of further agrochemical active compounds in dissolved form as well as low amounts of water in the composition further impede the stabilization of the suspended particles. Therefore, SC formulations are usually stabilized by dispersants and/or thickeners.

It is principally known to add thickeners to aqueous suspension concentrates for stabilization. In aqueous systems, carbohydrate-based thickeners may be used.

For example, WO2015/124330A1 discloses an aqueous pesticide suspension containing a suspended pesticide compound and thickener comprising a cellulose ether, such as methylcellulose and hydroxypropyl methylcellulose, in combination with xanthan gum or with an inorganic thickeners. JP2013-155137A discloses an aqueous suspension concentrate of an agricultural activing containing thickener xanthan gum as a thickener and a protective colloid, such as polyvinyl alcohol, methylcellulose or hydroxypropyl methylcellulose, for improving the adhesion of the sprayed formulation to rice plants.

When trying to co-formulate a water-insoluble agricultural active with a water-soluble agricultural active as an aqueous suspension concentrate described at the beginning using the thickeners described in the prior art, the aqueous suspension concentrate turned to be instable upon storage, in particular when the water-insoluble pesticide is pyroxasulfone and/or when the water-soluble agricultural active is present at concentrations of 20 wt % or higher. In particular, irreversible segregation or solidification was observed.

It was now found that these problems are solved by including a combination of three carbohydrate thickeners, in particular of xanthan gum, guar gum and a cellulose based thickener, in particular methylcellulose and/or hydroxypropyl methylcellulose into an aqueous suspension concentrate formulation as described in the beginning. This combination of carbohydrate based thickeners, hereinafter thickener system, conveys an improved physical stability to the aqueous agrochemical suspension, which effect is even achieved at high loads of the respective agricultural actives and consequently at low water contents of e. g. up to or below 50 wt %, based on the total weight of the suspension concentrate. Specifically, the agrochemical suspension concentrates have a very good storage stability, even at high salt concentrations, and no or reduced particle size growth.

Hence, in a first aspect the invention relates to aqueous agrochemical suspension concentrate formulations which comprise
a) 1 to 40 wt %, in particular 2 to 35 wt %, preferably 5 to 30 wt %, especially 7 to 25 wt %, based on the total weight of the agrochemical suspension concentrate formulation, of at least one first agrochemical active compound, in particular pyroxasulfone, in the form of particles suspended in an aqueous phase (component a);
b) 5 to 75 wt %, in particular 10 to 70 wt %, preferably 12 to 65 wt %, especially 15 to 60 wt %, based on the total weight of the agrochemical suspension concentrate formulation, of at least one second agrochemical active compound, in particular a salt of dicamba and/or a salt of an imidazolinone herbicide, which is dissolved in the aqueous phase; (component b);
c) a thickener system (component c) comprising
   c.1) xanthan gum,
   c.2) guar gum and
   c.3) a cellulose-based thickener,
d) an aqueous phase comprising water (component d).

A second aspect the invention relates to the production of the aqueous agrochemical suspension concentrate formulations of the present invention, which comprises the steps of
A) providing a liquid aqueous suspension comprising suspended particles of the at least one first agrochemical active and a portion of the thickener system;
B) providing a liquid aqueous solution comprising the at least one second agrochemical active compound;
C) providing the remainder of the thickener system;
D) mixing the suspension provided in step A), the solution provided in step B) and the remainder of the thickener system in any given order.

Further aspects of the invention relate to
the use of an aqueous agrochemical suspension concentrate formulation of the present invention in agriculture, in particular for controlling undesired vegetation and/or plant pathogenic organisms, such as plant pathogenic fungi or invertebrate pests, and/or for regulating the growth of plants and/or for treating plant propagation materials;
a method for controlling undesired vegetation and/or plant pathogenic organisms, such as plant pathogenic fungi or invertebrate pests, and/or for regulating the growth of plants, where an agrochemical suspension concentrate formulation of the present invention is allowed to act on the respective pests, their environment, the crop plants to be protected from the respective pest, the plant propagation material of the crop plants and/or the environment of the crop plants;
a method for the treatment of plant propagation material comprising the treatment of the plant propagation material with the aqueous agrochemical suspension concentrate formulation of the present invention;
the use of the thickener system comprising the components c.1, c.2 and c.3 as disclosed herein for stabilizing an aqueous an aqueous agrochemical suspension concentrate formulation, in particular for improving the storage stability thereof, where the aqueous agrochemical suspension concentrate formulation comprises at least one first agrochemical active compound in the form of particles suspended in an aqueous phase and at least one second agrochemical active compound which is dissolved in the aqueous phase.

The present invention is associated with several benefits. The aqueous agrochemical suspension concentrate formulations of the present invention have high physical stability even at high loads of the respective agricultural actives and high salt concentrations. In particular, they have a very good storage stability even at elevated temperature, and do no show significant particle size growth or agglomeration of the dispersed first agrochemical active compound. Apart from that, the viscosities aqueous agrochemical suspension concentrate formulations of the present invention do not significantly alter upon storage. Moreover, the aqueous agrochemical suspension concentrates can be easily diluted with water and the formation of small droplets during spray application is low. Furthermore, the aqueous agrochemical suspension concentrates of the present invention are compatible with other agricultural formulations, in particular formulations of water soluble pesticides, such as imidazolinones, glyphosate or glufosinate or salts thereof, in tank mix applications. Furthermore, the cleanout of the formulations from agricultural machinery is very user-friendly, that primary and secondary losses of active compounds are reduced. Further advantages are a reduced phytotoxicity to crop plants and increased biological efficiency against pests.

In the context of the present invention the terms “aqueous agrochemical suspension concentrate formulations”, “aqueous agrochemical suspension concentrates”, “suspension concentrate formulations”, “suspension concentrates” and “SC formulations” are used synonymously and refer to the aqueous agrochemical suspension concentrate formulations of the present invention.

Here and in the following, the terms “wt %” and “% by weight” are used synonymously and refer to the concentration of a specific compound in the aqueous agrochemical suspension concentrate on a weight basis.

The term “agrochemical active compound” refers to a substance that confers a desirable biological activity to the aqueous agrochemical suspension concentrate. Typically, the agrochemical active compound is a pesticide. Agrochemical active compounds may generally be selected from fungicides, insecticides, nematicides, herbicides, safeners, nitrification inhibitors, urease inhibitors, plant growth regulators, micronutrients and/or biopesticides. The skilled worker is familiar with such pesticides, which can be found, for example, in the Pesticide Manual, 16th Ed. (2013), The British Crop Protection Council, London.

In one embodiment, the agrochemical active compounds contained in the aqueous agrochemical suspension concentrate comprise at least one insecticide.

In another embodiment, the agrochemical active compounds contained in the aqueous agrochemical suspension concentrate comprise at least one insecticide.

In yet another particularly preferred embodiment, the agrochemical active compounds contained in the aqueous agrochemical suspension concentrate comprise at least one herbicide. In particular, both the first agrochemical active compound and the second agrochemical active compound are selected from the group of herbicides.

Suitable insecticides are insecticides from the class of the carbamates, organophosphates, organochlorine insecticides, phenylpyrazoles, pyrethroids, neonicotinoids, spinosins, avermectins, milbemycins, juvenile hormone analogs, alkyl halides, organotin compounds nereistoxin analogs, benzoylureas, diacylhydrazines, METI acarizides, and insecticides such as chloropicrin, pymetrozin, flonicamid, clofentezin, hexythiazox, etoxazole, diafenthiuron, propargite, tetradifon, chlorofenapyr, DNOC, buprofezine, cyromazine, amitraz, hydramethylnon, acequinocyl, fluacrypyrim, rotenone, or their derivatives.

Suitable fungicides are fungicides from the classes of dinitroanilines, allylamines, azole fungicides, anilinopyrimidines, antibiotics, aromatic hydrocarbons, benzenesulfonamides, benzimidazoles, benzisothiazoles, benzophenones, benzothiadiazoles, benzotriazines, benzyl carbamates, carbamates, carboxamides, carboxylic acid diamides, chloronitriles cyanoacetamide oximes, cyanoimidazoles, cyclopropanecarboxamides, dicarboximides, dihydrodioxazines, dinitrophenyl crotonates, dithiocarbamates, dithiolanes, ethylphosphonates, ethylaminothiazolecarboxamides, guanidines, hydroxy-(2-amino)pyrimidines, hydroxyanilides, imidazoles, imidazolinones, inorganic substances, isobenzofuranones, methoxyacrylates, methoxycarbamates, morpholines, N-phenylcarbamates, oxazolidinediones, oximinoacetates, oximinoacetamides, peptidylpyrimidine nucleosides, phenylacetamides, phenylamides, phenylpyrroles, phenylureas, phosphonates, phosphorothiolates, phthalamic acids, phthalimides, piperazines, piperidines, propionamides, pyridazinones, pyridines, pyridinylmethylbenzamides, pyrimidinamines, pyrimidines, pyrimidinonehydrazones, pyrroloquinolinones, quinazolinones, quinolines, quinones, sulfamides, sulfamoyltriazoles, strobilurins, thiazolecarboxamides, thiocarbamates, thiophanates, thiophenecarboxamides, toluamides, triphenyltin compounds, triazines, triazoles.

Suitable herbicides are herbicides from the classes of the acetamides, amides, aryloxyphenoxypropionates, benzamides, benzofuran, benzoic acids, benzothiadiazinones, bipyridylium, carbamates, chloroacetamides, chlorocarboxylic acids, cyclohexanediones, dinitroanlines, dinitrophenol, diphenyl ether, glycines, imidazolinones, isoxazoles, isoxazolidinones, nitriles, N-phenylphthalimides, oxadiazoles, oxazolidinediones, oxyacetamides, phenoxycarboxylic acids, phenylcarbamates, phenylpyrazoles, phenylpyrazolines, phenylpyridazines, phosphinic acids, phosphoroamidates, phosphorodithioates, phthalamates, pyrazoles, pyridazinones, pyridines, pyridinecarboxylic acids, pyridinecarboxamides, pyrimidinediones, pyrimidinyl(thio)benzoates, quinolinecarboxylic acids, semicarbazones, sulfonylaminocarbonyltriazolinones, sulfonylureas, tetrazolinones, thiadiazoles, thiocarbamates, triazines, triazinones, triazoles, triazolinones, triazolocarboxamides, triazolopyrimidines, triketones, uracils, ureas.

Preferred herbicides include
water soluble herbicides compounds selected from glufosinate, in particular L-glufosinate or a salt thereof, glyphosate or a salt thereof, imidazolinones, such as imazamox, imazapic, imazapyr, imazaquin and imazethapyr, benzoic acid herbicides, such as dicamba and tricamba, phenoxyacetic herbicides, such as 2,4-D, quinolone carboxylic acids, such as quinclorac and quinmerac, and in particular the salts thereof;
water-insoluble pesticides selected from pendimethalin, atrazine, isoxaflutole, indaziflam, diflufenzopyr, sulfentrazone, pyroxasulam, pyroxasulfone, topramezone, mesotrione, pinoxaden, picloram, picolinafen, mesosulfuron-methyl, saflufenacil, bentazone, metazachlor, and diflufenican.

Suitable plant growth regulators are antiauxins, auxins, cytokinins, defoliants, ethylene modulators, ethylene releasers, gibberellins, growth inhibitors, morphactins, growth retardants, growth stimulators, and further unclassified plant growth regulators. Suitable micronutrients are compounds comprising boron, zinc, iron, copper, manganese, chlorine, and molybdenum.

Suitable nitrification inhibitors are linoleic acid, alpha-linolenic acid, methyl p-coumarate, methyl ferulate, methyl 3-(4-hydroxyphenyl) propionate (MHPP), Karanjin, brachialacton, p-benzoquinone sorgoleone, 2-chloro-6-(trichloromethyl)-pyridine (nitrapyrin or N-serve), dicyandiamide (DCD, DIDIN), 3,4-dimethyl pyrazole phosphate (DMPP, ENTEC), 4-amino-1,2,4-triazole hydrochloride (ATC), 1-amido-2-thiourea (ASU), 2-amino-4-chloro-6-methylpyrimidine (AM), 2-mercapto-benzothiazole (MBT), 5-ethoxy-3-trichloromethyl-1,2,4-thiodiazole (terrazole, etridiazole), 2-sulfanilamidothiazole (ST), ammoniumthiosulfate (ATU), 3-methylpyrazol (3-MP), 3,5-dimethylpyrazole (DMP), 1,2,4-triazol thiourea (TU), N-(1H-pyrazolyl-methyl)acetamides such as N-((3(5)-methyl-1H-pyrazole-1-yl)methyl)acetamide, and N-(1H-pyrazolyl-methyl)formamides such as N-((3(5)-methyl-1H-pyrazole-1-yl)methyl formamide, N-(4-chloro-3(5)-methyl-pyrazole-1-ylmethyl)-formamide, N-(3(5),4-dimethylpyrazole-1-ylmethyl)-formamide, neem, products based on ingredients of neem, cyanamide, melamine, catechol, benzoquinone, sodium terta board, zinc sulfate, 2-(3,4-dimethyl-1H-pyrazol-1-yl)succinic acid (referred to as “DMPSA1” in the following) and/or 2-(4,5-dimethyl-1H-pyrazol-1-yl)succinic acid (referred to as “DMPSA2” in the following), and/or a derivative thereof, and/or a salt thereof; glycolic acid addition salt of 3,4-dimethyl pyrazole (3,4-dimethyl pyrazolium glycolate, referred to as “DMPG” in the following), and/or an isomer thereof, and/or a derivative thereof; citric acid addition salt of 3,4-dimethyl pyrazole (3,4-dimethyl pyrazolium citrate, referred to as “DMPC” in the following), and/or an isomer thereof, and/or a derivative thereof; lactic acid addition salt of 3,4-dimethyl pyrazole (3,4-dimethyl pyrazolium lactate, referred to as “DMPL” in the following), and/or an isomer thereof, and/or a derivative thereof; mandelic acid addition salt of 3,4-dimethyl pyrazole (3,4-dimethyl pyrazolium mandelate, referred to as “DMPM” in the following), and/or an isomer thereof, and/or a derivative thereof; 1,2,4-triazole (referred to as “TZ” in the following), and/or a derivative thereof, and/or a salt thereof; 4-Chloro-3-methylpyrazole (referred to as “CIMP” in the following), and/or an isomer thereof, and/or a derivative thereof, and/or a salt thereof; a reaction adduct of dicyandiamide, urea and formaldehyde, or a triazonyl-formaldehyde-dicyandiamide adduct; 2-cyano-1-((4-oxo-1,3,5-triazinan-1-yl)methyl)guanidine, 1-((2-cyanoguanidino)methyl)urea; 2-cyano-1-((2-cyanoguanidino)methyl)guanidine; 3,4-dimethyl pyrazole phosphate; allylthiourea, and chlorate salts.

Examples of envisaged urease inhibitors include N-(n-butyl) thiophosphoric acid triamide (NBPT, Agrotain), N-(n-propyl) thiophosphoric acid triamide (NPPT), 2-nitrophenyl phosphoric triamide (2-NPT), further NXPTs known to the skilled person, phenylphosphorodiamidate (PPD/PPDA), hydroquinone, ammonium thiosulfate, and mixtures of NBPT and NPPT (see e.g. U.S. Pat. No. 8,075,659). Such mixtures of NBPT and NPPT may comprise NBPT in amounts of from 40 to 95% wt.-% and preferably of 60 to 80% wt.-% based on the total amount of active substances. Such mixtures are marketed as LIMUS, which is a composition comprising about 16.9 wt.-% NBPT and about 5.6 wt.-% NPPT and about 77.5 wt.-% of other ingredients including solvents and adjuvants.

Preferably, both the first and the second agrochemical active compounds have a melting point of at least 60 °C, e. g. in the range of 60 to 300 °C. This will result in a reduced volatility of the active compound in the liquid aqueous agrochemical suspension concentrate formulation. Moreover, in the case of the first (insoluble) agrochemical active compound, a melting point of at least 60 °C is preferred as this will ensure that it will not melt at high storage temperatures that otherwise may cause sedimentation and/or phase separation. The suspended particles of the first agrochemical active compound may be present in the form of crystalline or amorphous particles. Preferably, they are crystalline.

The first agrochemical active compound comprises any one or any combination of the above mentioned agrochemical active compounds as long as they are sufficiently insoluble in water. Generally, the first agrochemical active compound may have a water-solubility in deionized water at 20 °C, 1 bar and pH 7 of less than 2 g/l, preferably less than 1 g/l, especially at most 0.5 g/l.

In the SC formulation of the present invention, the first agrochemical active compound is present in the form of suspended particles in the aqueous phase of the SC formulation. Typically, at least 90 wt %, preferably at least 95 wt %, more preferably at least 98 wt % of the first agrochemical active compound are present as solid particles based on the total weight of the first agrochemical active compound in the SC formulation.

The particles of the first agrochemical active compound may be characterized by their size distribution, which can be determined by laser light scattering techniques according to ISO 13320-1:2020. Suitable laser light scattering measurement units are inter alia produced under the trade name Malvern Mastersizer 3000 and Malvern Mastersizer 2000. The particles of the first agricultural active compound. may be characterized by their median diameter, which is usually abbreviated as D50 value. The D50 value refers to a particular particle diameter, wherein half of the particle population by volume is smaller than this diameter. The D50 value is typically determined according to ISO 13320-1:2020 applying the Mie Model to the laser diffraction data. Generally, the particles of the first agriculturally active compound have a D50 value in the range of 0.1 μm to 30 μm, frequently in the range of 0.2 μm to 20 μm, preferably in the range of 0.5 to 20 μm, more preferably in the range of 0.5 μm to 15 μm, especially in the range of 0.8 μm to 10 μm. Preferably, at least 90% by volume of the particles have a particle size of not more than 30 μm.

The concentration of the first agrochemical active compound is typically in the range of 1 to 40 wt %, preferably in the range of 2 to 35 wt %, more preferably in the range of 5 to 30 wt %, especially in the range of 7 to 28% by weight, based on the total weight of the SC formulation.

Preferably, the first agrochemical active compound is a herbicide compound. In particular, it is selected from the group consisting of pendimethalin, atrazine, isoxaflutole, indaziflam, diflufenzopyr, sulfentrazone, pyroxasulam, pyroxasulfone, topramezone, mesotrione, pinoxaden, picloram, picolinafen, mesosulfuron-methyl, saflufenacil, bentazone, metazachlor, and diflufenican. Especially, the first herbicide compound is pyroxasulfone.

The at least one second agrochemical active compound is present in dissolved in the continuous aqueous phase. The at least one second agrochemical active compound is typically readily water-soluble. The second agrochemical active compound usually has a water-solubility in deionized water at 20 °C of at least 50 g/l, in particular at least 100 g/l or at least 200 g/l or is completely miscible with deionized water.

The concentration of the second agrochemical active compound is typically in the range of 5 to 75 wt %, in particular in the range of 10 to 70 wt %, preferably in the range of 12 to 65 wt %, especially in the range of 15 to 60 wt % or 40 to 60 wt %, based on the total weight of the SC formulation.

In the SC formulation of the present invention, the second agrochemical active compound is present dissolved in the aqueous phase of the SC formulation. Typically, at least 90 wt %, preferably at least 95 wt %, more preferably at least 98 wt % or the total amount of the second agrochemical active compound are present dissolved, based on the total weight of the second agrochemical active compound in the SC formulation.

Preferably, the second agrochemical active compound is a herbicide compound. In particular, it is selected from the group consisting of the salts of glufosinate, in particular L-glufosinate, the salts of glyphosate, the salts of imidazolinones, such as imazamox, imazapic, imazapyr, imazaquin and imazethapyr, the salts of benzoic acid herbicides, such as the salts of dicamba and tricamba, the salts of phenoxyacetic herbicides, such as 2,4-D, and the salts of quinolone carboxylic acids, such as quinclorac and quinmerac. In particular, the second agrochemical active compound is selected from the group consisting of the salts of dicamba, the salts of glufosinate, the salts of glyphosate and the salts of imidazolinone herbicides. Especially, the second agrochemical active compound is a salt of dicamba.

Especially, the first agrochemical active compound is pyroxasulfone and the second agrochemical active compound is selected from the group consisting of the salts of dicamba, the salts of glufosinate, the salts of glyphosate and the salts of imidazolinone herbicides.

In a particularly preferred group 1 of embodiments, the present invention relates to an aqueous agrochemical suspension concentrate formulations which comprise
a) from 1 to 30 wt %, in particular 2 to 25 wt %, preferably 5 to 20 wt %, especially 7 to 15 wt %, based on the total weight of the agrochemical suspension concentrate formulation, of pyroxasulfone, in the form of particles suspended in an aqueous phase (component a);
b) 5 to 75 wt %, in particular 10 to 70 wt %, preferably 20 to 65 wt %, especially 40 to 60 wt %, based on the total weight of the agrochemical suspension concentrate formulation, of at least one second agrochemical active compound, which is selected from a salt of dicamba, which is dissolved in the aqueous phase (component b), where the salt of dicamba is in particular of a salt of dicamba with a water-miscible amine;
c) a thickener system (component c) as described herein
d) and an aqueous phase comprising water (component d).

In a particularly preferred group 2 of embodiments, the present invention relates to an aqueous agrochemical suspension concentrate formulations which comprise
a) from 2 to 40 wt %, in particular 5 to 35 wt %, preferably 10 to 30 wt %, especially 15 to 28 wt %, based on the total weight of the agrochemical suspension concentrate formulation, of pyroxasulfone, in the form of particles suspended in an aqueous phase (component a);
b) 5 to 50 wt %, in particular 10 to 40 wt %, preferably 10 to 30 wt %, especially 12 to 25 wt %, based on the total weight of the agrochemical suspension concentrate formulation, of at least one second agrochemical active compound, which is selected from a salt of an imidazolinone herbicide, which is dissolved in the aqueous phase (component b) where the salt of the imidazolinone herbicide is in particular of a salt of the imidazolinone with an alkalimetal ion or an ammonium ion;
c) a thickener system (component c) as described herein
d) and an aqueous phase comprising water (component d).

Suitable salts of the second agrochemical active compound include those where the counterion is an agriculturally acceptable cation. In one embodiment, the pesticide is a metal salt of dicamba, such as a lithium, sodium, potassium, magnesium, or calcium salt. In another embodiment the dicamba salt is preferably an ammonium salt of dicamba, i. e. a salt of dicamba with ammonia or with a water-miscible amine. In this context, the term “water miscible” refers to amines that are completely miscible with deionized water a temperature of 25 °C and 1 bar or which are soluble in water at a temperature of 25 °C and 1 bar in an amount of at least 100 g/i.

Suitable organic amines miscible with water are those which have at least one amino group, wherein 1, 2 or 3 of the amino hydrogen atoms are replaced by an alkyl group, a hydroxyalkyl group, an alkoxyalkyl group, a hydroxyalkyloxyalkyl group, an aminoalkyl group, an alkylaminoalkyl group, a dialkylaminoalkyl group, a N-(aminoalkyl)aminoalkyl, a N—(N′,N′-dialkylaminoalkyl)aminoalkyl group etc. In this context alkyl and alkoxy have preferably 1 to 4carbon atoms, in particular 1 or 2 carbon atoms, while the substituted alkyl moieties of alkoxyalkyl, hydroxyalkyloxyalkyl, aminoalkyl group, alkylaminoalkyl, dialkylaminoalkyl, N-(aminoalkyl)aminoalkyl and N—(N′,N′-dialkylaminoalkyl)aminoalkyl preferably have 2 to 4 carbon atoms.

Preference is given to amines that have a primary or secondary amino group and at least one further functional group which is selected from a primary amino group, a secondary amino group, a tertiary amino group, a hydroxyl group, and an ether group.

Examples of suitable amines which are miscible with water include but are not limited to dimethylamine, diethylamine, n-propylamine, isopropylamine, 2-hydroxyethylamine (olamine or MEA), 2-(2-hydroxyethoxy)eth-1-ylamine (diglycolamine or DGA), di(2-hydroxyeth-1-yl)amine (diolamine), tri(2-hydroxyethyl)amine (trolamine), tris(3-propanol)amine, tris-hydroxypropyl)amine (tripromine), N-(3-aminopropyl)-N-methylamine, N, N-bis-(3-aminopropyll)-N-methylamine (biproamine, BAPMA), N,N-dimethyldipropylenetriamine (DMAPAPA). Further examples are oligomeric amines having a number average molecular weight in the range of 200 to 500 g/mol, such as polyetheramines, like Jeffamine types having a number average molecular weight in the range of 200 to 500 g/mol and oligomeric polyamines such as polyalkylene imines and N-substituted polyalkyleneimines, such as poly-N,N-bis-(3-aminopropyl)methylamine (MPPI).

Preference is given to formulations where the second agrochemical active compound is a salt of dicamba with an amine selected from the group consisting of monoalkanolamines, N,N-dialkanolamines, N-(dialkyleneglycol)amines and N(aminoalkyl)alkylamines, N,N-bis(aminoalkyl)alkylamines and N—(N,N-dialkylaminoalkylamino)alkylamine, in particular from the group consisting of mono-C₂-C₄-alkanolamines, N,N-bis(C₂-C₄-alkanol)amines, N-(di-C₂-C₄-alkyleneglycol)amines and N-(amino-C₂-C₄-alkyl)-C₁-C₂-alkylamines, N,N-bis(amino-C₂-C₄-alkyl)-C₁-C₂-alkylamines, N—(N′,N′-di-C₁-C₂-alkylamino-C₂-C₄-alkyl)-C₁-C₂-alkylamines and especially from the group consisting of N-(di-C₂-C₄-alkyleneglycol)amines and N, N-bis(amino-C₂-C₄-alkyl)-C₁-C₂-alkylamines.

Amongst these, preference is given to formulations, where the second agrochemical active compound is a salt of dicamba with an amine which is selected from the group consisting of 2-hydroxyethylamine (olamine or MEA), 2-(2-hydroxyethoxy)eth-1-ylamine (diglycolamine or DGA), di(2-hydroxyeth-1-yl)amine (diolamine), tri(2-hydroxyethyl)amine (trolamine), N-(3-aminopropyl)-N-methylamine, N, N-bis-(3-aminopropyl)N-methylamine (BAPMA) and N,N-dimethyldipropylenetriamine (DMAPAPA), and where the amine is especially DGA or BAPMA.

Especially, the second agrochemical active compound is the N,N-bis-(3-aminopropyl)methylammonium salt of dicamba (or “dicamba-BAPMA”).

Especially, the invention relates to SC formulations, where the at least one first agrochemical active compound is pyroxasulfone and the at least one second agrochemical active compound is dicamba or a salt thereof, as defined above.

The SC formulation contains water, which serves to dissolve the second agrochemical active compound and the thickener system and optionally further ingredients. It is thus part of the aqueous phase. The amount of water in the SC formulation is generally at least 10 wt %, in particular at least 15 wt %, especially at least 20 wt % or at least 25 wt %, based on the total weight of the SC formulation. The amount is generally up to 90 wt %, based on the total weight of the SC formulation. The agrochemical composition preferably contains up to 80 wt % of water, more preferably up to 70 wt %, especially up to 60 wt % of water, each time based on the total weight of the suspension.

According to the invention, the SC formulation contains a thickener system comprising xanthan gum, guar gum, and a cellulose-based thickener. The SC formulation may contain the thickener system in a concentration of from 0.1 to 20 g/l, preferably from 0.5 to 15 g/l, more preferably from 1 to 10 g/l.

Guar gum (CAS number 9000-30-0), also called guaran, is a galactomannan polysaccharide that may be obtained from guar beans. It is composed of the sugars galactose and mannose.

Typically, the SC formulation contains guar gum in a concentration of from 0.01 g/l to 5 g/l, preferably from 0.1 to 2 g/l, more preferably from 0.1 to 1 g/l. The SC formulation may contain guar gum in a concentration of up to 10 g/l, preferably up to 3 g/l, more preferably up to 1.5 g/l, most preferably up to 0.8 g/l, such as up to 0.6 g/l. The SC formulation may contain guar gum in a concentration of at least 0.05 g/l, preferably at least 0.2 g/l.

Xanthan gum (CAS number 11138-66-2) is a polysaccharide known to the skilled person. It is composed of pentasaccharide repeat units comprising glucose, mannose, and glucuronic acid. The SC formulation typically contains xanthan gum in a concentration of from 0.01 g/l to 5 g/l, preferably from 0.05 to 2 g/l, more preferably from 0.05 to 1 g/l. The SC formulation may contain xanthan gum in a concentration of up to 2 g/l, preferably up to 0.5 g/l, more preferably up to 0.3 g/l, most preferably up to 0.2 g/l. The SC formulation may contain xanthan gum in a concentration of at least 0.05 g/l, preferably at least 0.1 g/l.

Cellulose-based thickeners are known to the skilled person and commercially available. Typically, cellulose-based thickeners are cellulose ethers. Examples of cellulose-based thickeners are methylcellulose, hydroxypropyl methylcellulose, hydroxyethyl cellulose, hydroxyethyl methylcellulose, hydroxypropyl cellulose, carboxymethyl cellulose, and mixtures thereof. Preferably, the cellulose based thickener is non-ionic and does not bear carboxyl groups. In a preferred embodiment, the cellulose-based thickener is selected from hydroxypropyl methylcellulose and methylcellulose. Especially, the cellulose-based thickener is hydroxypropyl methyl cellulose. In another embodiment, the cellulose-based thickener is methylcellulose.

In case the cellulose-based thickener is hydroxypropyl methylcellulose, it generally has 10 to 40 wt %, preferably 15 to 35 wt %, more preferably 18 to 30 wt % of methoxy groups, based on the total weight of the hydroxypropyl methylcellulose.

In case the cellulose-based thickener is a hydroxypropyl methylcellulose, it generally has 5 to 15 wt %, preferably 6 to 13 wt %, more preferably 7 to 12 wt % of hydroxypropoxy groups, based on the total weight of the hydroxypropyl methylcellulose

In case the cellulose-based thickener is methylcellulose, it generally has 10 to 40 wt %, preferably 15 to 35 wt %, more preferably 18 to 30 wt % of methoxy groups, based on the total weight of the methylcellulose.

In case the cellulose-based thickener is methylcellulose, it may typically have 25 to 35 wt % of methoxy groups, preferably 27 to 32 wt % of methoxy groups.

The amount of methoxy groups in methylcellulose and hydroproxypropyl methylcellulose as well as the hydroxyproxy groups in hydroproxypropyl methylcellulosecan be determined according United States Pharmacopoeia (USP30 NF25) United States Pharmacopoeia Convention, Inc., 2007, p 2323 using the so-called Zeisler alkoxy reaction including a treatment with hydroiodic acid followed by quantitative gaschromatography of the liberated methyliodide and 2-propyliodide (see DOW Analytical Method DOWM 100755-ME0OB, The Dow Chemical Company, 2002) or preferably by ¹H-NMR spectroscopy as described in §§ 204-206 of US2011/0319383.

The dynamic viscosity of a 2 wt % solution of the hydroxypropyl methylcellulose thickener in water at 20 °C is typically from 3000 to 6000 cP, preferably from 3500 to 5600 cP. The dynamic viscosity can be measured with a viscosimeter according to EN ISO 3219, such as with a rotational viscosimeter or a Ubbelohde viscosimeter.

The dynamic viscosity of a 2 wt % solution of the methylcellulose thickener in water at 20 °C is typically from 3000 to 6000 cP, preferably from 3000 to 5600 cP, more preferably from 3800 to 4200 cP. The dynamic viscosity can be measured with a viscosimeter according to EN ISO 3219, such as with a rotational viscosimeter or a Ubbelohde viscosimeter.

The SC formulation may contain the cellulose-based thickener in a concentration of 0.5 to 20 g/l, preferably 1 to 10 g/l, more preferably 2 to 8 g/l. The SC formulation may contain the cellulose-based thickener in a concentration of at least 0.1 g/l, preferably at least 1.5 g/l. The SC formulation may contain the cellulose-based thickener in a concentration of up to 15 g/l, preferably up to 6 g/l.

The weight ratio of the cellulose-based thickener to the guar gum is typically from 1:2 to 50:1, preferably from 1:1 to 20:1, more preferably from 2:1 to 15:1, such as from 3:1 to 12:1.

The weight ratio of the guar gum to the xanthan gum is typically from 1:2 to 10:1, preferably from 1:1 to 20:1, more preferably from 3:1 to 15:1 The SC formulation may further contain an inorganic or organic buffer (component e) to stabilize the pH of the aqueous spray liquor which is obtained by dilution of the SC formulation with water. The pH of a 1.39 wt % aqueous dilution the buffered SC formulation is typically in the range of 7 to 10, preferably in the range of 8 to 10, such as from 8.5 to 9.5, as determined by CIPAC MT 75.3.

The buffer is typically a carbonate or a citrate-based buffer, or a mixture thereof, which is in particular selected from alkalimetal carbonates and alkalimetal citrates. For example, the buffer may be potassium carbonate (K₂CO₃) or potassium citrate (tri-potassium citrate), or a mixture thereof.

The SC formulation may contain the buffer in a concentration of from 5 to 25 wt %, preferably from 8 to 20 wt %, especially from 10 to 15 wt %.

The SC formulation may further contain at least one anionic dispersant F (component f) which bears at least one anionic group selected from sulfonate, sulfate, phosphonate and phosphate groups. Suitable anionic dispersants F include, but are not limited to, the following groups of dispersants:
F.1 aryl- and C₁-C₁-alkylarylsulfonates such as naphthylsulfonate, mono-, di- and tri-C₁-C₁₆-alkylnaphthylsulfonates such as dibutylnaphtylsulfonate, dodecyldiphenylether sulfonate, mono-, di- and tri-C₁-C₁₃-alkylphenylsulfonates such as cumylsulfonate, octylbenzene sulfoanate, nonylbenzenesulfonate, dodecylbenzene sulfonate and tridecylbenzene sulfonate;
F.2 aryl ether sulfates, in particular aryl poly(C₂-C₃-alkylene oxide) ether sulfates, e.g. the sulfates of (poly)ethoxylated di- or tristyrylphenols and the sulfates of (poly)ethoxylatedco-propoxylated di- or tristyrylphenols;
F.3 aryl ether phosphates, in particular aryl poly(C₂-C₃-alkylene oxide) ether phosphates, e.g. the phosphate esters of (poly)ethoxylated di- or tristyrylphenols and the phosphate esters of (poly)ethoxylated-co-propoxylated di- or tristyrylphenols;
F.4 condensates of arylsulfonic acid, such as naphthalenesulfonic acid or phenolsulfonic acid, with formaldehyde and condensates of arylsulfonic acid, such as naphthalenesulfonic acid or phenolsulfonic acid, with formaldehyde and urea; The anionic dispersants F are usually present in the formulation of the invention as their salts, in particular the ammonium salts, the alkaline metal salts, such as the sodium or potassium salt, and the earth alkaline metal salts, in particular the calcium salts.

In the group of surfactants F.1 preference is given to mono- or di-C₄-C₈-alkylnaphthalene sulfonic acid and mono- or di-C₄-C₁₆-alkylbenzesulfonic acid and the ammonium salts, the alkaline metal salts, such as the sodium or potassium salt, and the earth alkaline metal salts, in particular the calcium salts thereof. Particularly suitable examples are Morwet® EFW (Akzo Nobel), and the like.

In the group of surfactants F.2 preference is given to the ammonium salts, alkaline metal salts and earth alkaline metal salts of sulfates of (poly)ethoxylated di- or tristyrylphenols, in particular of those having from 5 to 70, in particular 10 to 60 or 15 to 50 ethylenoxide repeating units. Particularly suitable examples of sulfates of (poly)ethoxylated di- or tristyrylphenols are Soprophor® 4D384 of Solvay and the like.

In the group of surfactants F.3 preference is given to the ammonium salts and alkaline metal salts of phosphates of (poly)ethoxylated di- or tristyrylphenols, in particular of those having from 5 to 50, in particular 10 to 50 or 15 to 50 ethylenoxide repeating units.

In the group of surfactants F.4 preference is given to the ammonium salts and alkaline metal salts of naphthalenesulfonic acid formaldehyde condensates and of naphthalenesulfonic acid urea formaldehyde condensates.

Preferred anionic dispersants F are those of the groups F.3 and F.4 and combinations thereof. In a particular preferred group of embodiments, the SC formulation of the present invention contains at least one anionic dispersant of the group F.3 and at least one anionic dispersant of the group F.4.

The total concentration of dispersants F, if present in the SC formulation of the present invention, is typically in the range of 0.1 to 5 wt %, in particular in the range of 0.3 to 3 wt %, based on the total weight of the of the SC formulation.

In addition to the mandatory components a, b and c and water (component d) and the optional components e and f, the SC formulation of the present invention may contain a water-immiscible organic solvent (component g). Here, the term “water-immiscible solvent” refers to organic solvents which have a solubility in deionized water at 20 °C and 1 bar of not more than 1 g/L. Suitable water-immiscible organic solvents include but are not limited to plant oils, aromatic hydrocarbons, fatty acid alkyl esters, in particular C₁—C-alkyl esters of C₈-C₂₆-fatty acids, such as methyl or ethyl esters, fatty acid amides, in particular di-C₁-C₄-alkyl amides of C₈-C₂-fatty acids and mixtures thereof. Typically, the concentration of the component g) does not exceed 10 wt % based on the total weight of the SC formulation, and is frequently in the range of 1 to 10 wt %, if present.

The SC formulation may also contain one or more non-ionic surfactants, in particular, if the SC formulation contains a component g. Usually, the polymeric dispersants D have a hydrophilic-lipophilic balance, i. e. a HLB value in the range of 3 to 18, in particular in the range of 5 to 15. Here and in the following, HLB values refer to the HLB values according to Griffin (W. C. Griffin, J. Soc. Cosmet. Chem. 1 (1950), p. 311, and J. Soc. Cosmet. Chem. 5 (1954), p. 249).

Examples of suitable non-ionic surfactants having a HLB in the above ranges include alkyl ethoxylates, alkyl ethoxylates-co-propoxylates, alkylphenol ethoxylates, alkylphenol ethoxylates-co-propoxylates, tributylphenol ethoxylates, tributylphenol ethoxylates-co-propoxylates, tristyrylphenol ethoxylates, tristyrylphenol ethoxylates-co-propoxylates, ethylene oxide-co-propylene, oxide block-co-polymers, fatty acid polyethyleneglycol esters, fatty acid polyglycerol esters, fatty acid polyglycerol ester ethoxylates, fatty acid polyglycerol ester ethoxylates-co-propoxylates, sorbitan ester ethoxylates, sorbitan ester ethoxylates-co-propoxylates, and, of course, castor oil ethoxylates and castor oil ethoxylates-co-propoxylates and mixtures thereof.

The total concentration of component g, if present in the SC formulation of the present invention, is typically in the range of 0.1 to 5 wt %, in particular in the range of 0.3 to 3 wt %, based on the total weight of the of the SC formulation.

The formulation of the present invention may contain one or more additives which may usually contained in aqueous formulations of organic pesticide compounds. These additives include, but are not limited to, anti-freeze agents, anti-foam agents, dyes, pigments and preservatives to prevent microbial spoiling.

In particular the formulation includes at least one anti-freeze. Suitable anti-freeze agents are typically water-soluble solvents, including alcohols, such as ethanol, ethylene glycol, propylene glycol and glycerol. The amount of such anti-freeze may depend on the type of anti-freeze and, if present, is typically in the range of 0.5 to 10 wt.-%, based on the total weight of the formulation.

Antifoam agents suitable for the formulations according to the invention are, for example, silicone emulsions (such as, for example, Silicone SRE-PFL from Wacker or Rhodorsil® from Bluestar Silicones), long-chain alcohols, fatty acids, organofluorine compounds and mixtures thereof. The amount of such antifoam may depend on the type of antifoam and, if present, is typically in the range of 0.01 to 0.5 wt.-%, based on the total weight of the formulation.

Suitable preservatives to prevent microbial spoiling of the compositions of the invention include formaldehyde, alkyl esters of p-hydroxybenzoic acid, sodium benzoate, 2-bromo-2-nitropropane-1,3-diol, o-phenylphenol, thiazolinones, such as 1,2-benzisothiazol-3(2H)-one, 5-chloro-2-methyl-4-isothiazolinone (CIT), methylisothiazolinon (MIT) pentachlorophenol, 2,4-dichlorobenzyl alcohol and mixtures thereof. Commercially available preservatives that are based on isothiazolinones are for example marketed under the trademarks Proxel® (Arch Chemical), Acticide® grades, such as MV, MBS and B20 (Thor Chemie) and Kathon® MK (Rohm & Haas). 2-bromo-2-nitropropane-1,3-diol is commercially available as Acticide® L30.

The SC formulations of the present invention are typically shear thinning, i. e. their dynamic viscosity decreases with increasing shear rates. Typically, the dynamic viscosity of the formulation of the present invention determined at 20 °C at a shear rate of 100 s⁻¹ does not exceed 2000 mPa·s in particular 200 mPa·s and is typically in the range of 20 to 1000 mPa·s.

The SC formulation can be prepared by analogy to well known methods, such as described by Mollet and Grubemann, Formulation technology, Wiley VCH, Weinheim, 2001; or Knowles, New developments in crop protection product formulation, Agrow Reports DS243, T&F Informa, London, 2005.

In one aspect, the invention relates to a method for preparing the SC formulation as defined above, comprising the steps of
A) providing a liquid aqueous suspension comprising suspended particles of the at least one first agrochemical active and a portion of the thickener system, in particular xanthan gum;
B) providing a liquid aqueous solution comprising the at least one second agrochemical active compound;
C) providing the remainder of the thickener system, in particular guar gum and a cellulose-based thickener;
D) mixing the suspension provided in step A), the solution provided in step B) and the remainder of the thickener system in any given order.

In step A of the process of the invention an aqueous suspension of at least one first agrochemical active, in particular pyroxasulfone, is provided, which contains a portion of the thickener system, in particular xanthan gum. Typically, the suspension contains at least one of the dispersants D, in particular at least one dispersant F in order to stabilize the suspension during production and storage. The suspension may also contain antifoam to avoid foaming during production.

In general, the sequence in which the individual components of the suspension are combined is not critical. However, it may be advantageous to carry out step A out by firstly mixing the water and a portion of the dispersant F and a portion of the thickener until a homogenous mixture is obtained, and then adding the the at least one first agrochemical active, in particular pyroxasulfone, with shear to said homogenous mixture. This yields a mixture including the components, wherein first active is present in the form of solid particles which are dispersed in the homogeneous aqueous phase formed by the water and the dispersant F. The mixture is then usually subjected to suitable means for reducing the particle size of the saflufenacil and pyroxasulfone particles present in the mixture typically to a mean particle size D[v, 0.5] below 10 μm, preferably to below 7 μm and in particular to below 5 μm. This step may be carried out by any physical attrition method, such as grinding, crushing or milling, in particular by wet grinding or wet milling, including e.g. bead milling, hammer milling, jet milling, air classifying milling, pin milling, cryogenic grinding processes and the like. Mixing and reducing particle size are usually performed subsequently. However it is also possible to perform these steps together. Step A is usually carried out at temperatures in the range of 10 to 60 °C.

In step B of the process of the invention, an aqueous solution of the at least one second agrochemical active compound is provided. The aqueous solution may contains a further portion of the thickener. The aqueous solution may also contain a buffer E, if present. The aqueous solution may also contain one or more bactericides and/or antifreeze. However, it is also possible to blend the final SC formulation with one or more bactericides and/or anti-freeze. The aqueous solution may also contain antifoam to avoid foaming during production of the emulsion in step D. The aqueous solution can be prepared simply by mixing the components of the aqueous solution in an arbitrary order. Step (B) is usually carried out at temperatures in the range of 10 to 70 °C and preferably in the range of 15 to 60 °C.

In step C of the process of the invention, the remainder of the thickener system is provided, in particular the guar gum and the cellulose-based thickener. Preferably, the remainder of the thickener system, in particular the guar gum and the cellulose-based thickener, are activated before usage by mixing with water, typically at a temperature of from 10 to 40 °C for a time period of preferably 10 minutes to 5 hours.

In step D) of the process of the invention, the suspension provided in step A), the solution provided in step B) and the remainder of the thickener system in any given order. The mixing in step D) may be achieved by mixing, shaking, homogenizing or wet milling, preferably to a median particle size as described herein. Optionally, one or more of the further ingredients, such as a defoamer, an antifreeze, bacterizides and/or water, are added at this stage.

The invention also relates to a method of controlling undesired vegetation, and/or for regulating the growth of plants, wherein the SC formulation is allowed to act on the respective pests, their environment, or the crop plants to be protected from the respective pest, on the soil and/or on the crop plants and/or on their environment.

The SC formulation is usually applied on the crop plants to be protected from the pests or undesired vegetation, on the soil and/or on the crop plants and/or on their environment. In one embodiment, the SC formulation is applied to the soil. In another embodiment, the SC formulation is applied to the foliage.

When employed in plant protection, the total application rates of first and the second agriculturally active compound, depending on the kind of effect desired, from 0.010 to 3 kg per ha, preferably from 0.050 to 2 kg per ha, more preferably from 0.2 to 1.5 kg per ha.

The application of the formulation of the invention or formulations or co-formulations of the individual herbicides of the combination of the invention may be carried out using water or a fluid nitrogen fertilizer as a spray carrier. For this, the respective formulations are diluted with water or the liquid nitrogen fertilizer to obtain a liquid spray liquor. Frequently, the amount of water used is at least 20 L/ha, in particular at least 25 L/ha and may be as high as 2000 L/ha.

The spray liquors can be applied in conventional manner by using techniques as skilled person is familiar with. Suitable techniques include spraying, atomizing, dusting, spreading or watering. The type of application depends on the intended purpose in a well-known manner; in any case, they should ensure the finest possible distribution of the active ingredients according to the invention.

The user applies the SC formulation according to the invention usually from a predosage device, a knapsack sprayer, a spray tank, a spray plane, or an irrigation system. Usually, the SC formulation is made up with water, buffer, and/or further auxiliaries to the desired application concentration and the ready-to-use spray liquor or the agrochemical composition according to the invention is thus obtained.

It is also possible to apply the formulations or combinations of the present invention in the form of fertilizer granules which have been impregnated with the formulations of the present invention or with formulations of the individual components.

To achieve a broader activity spectrum it may be possible to co-apply the formulation of the present invention or the combination of the present invention with a further herbicide. It is also possible to combine the application

Various types of oils, wetters, adjuvants, fertilizer, or micronutrients, and further pesticides (e.g. herbicides, insecticides, fungicides, growth regulators, safeners) may be added to SC formulation as premix or, if appropriate not until immediately prior to use (tank mix). These agents can be admixed with the SC formulation according to the invention in a weight ratio of 1:100 to 100:1.

The formulation of the present invention may be applied together with an adjuvant as action improver. A particular preferred adjuvant is described in WO 00/53014 and in WO 2010/037734. Said adjuvant is a combination of a C₁-C₅-alkyl C₅-C₂₂-alkanoate, a C₁₀-C₂₀-carboxylic acid, a partial phosphoric or sulfuric acid ester of a monohydroxy-functional polyalkyl ether and an alkyl polyoxyalkylene polyether. Preferred C₁-C₅-alkyl C₅-C₂₂-alkanoates are methyl oleate, methyl palmitate and ethyl oleate and mixtures thereof. Specifically, the C₁-C₅-alkyl C₅-C₂₂-alkanoate comprises at least 70% by weight of methyl oleate or of a mixture of methyl oleate and methyl palmitate. Such action improver systems are commercially available under the name DASH®, e.g. DASH® HC, from BASF Corporation, USA.

Further action improvers include but are not limited to those adjuvants conventionally used in combination with glyphosate, such as non-ionic surfactants (NIS), ammonium sulfate, alkyl sulfates of C₆₋₁₈ alkanols such as sodium dodecyl sulfate, alkyl ether sulfates of C₆₋₁₈ alkanols, methylated soybean oil (MSO) and crop oil concentrate (COC).

In case the first and the second agricultural active compound are from the group of herbicides, the SC formulation of the present invention are suitable for controlling undesired plant growth, in particular undesired plant growth in crop. For this, the aqueous formulation is applied to the undesired plants or to an area where the undesired plants will grow.

The formulation of the invention and the combinations of the invention can be applied in numerous crops. The crops include in particular field corn, including field corn grown for producing grain, seed or silage, popcorn, sweet corn, soybean, chickpea, edible pea, field pea, lentils, including green and red type, perennial grasses, in particular when grown for seed production, alfalfa, in particular in established stands of dormant alfalfa, in cereals, legume and oilseed cover crops. The formulations are active against broad-leaved weeds and grass weeds without inflicting substantial damage to the crop plants. For this, the formulations and the combinations of the invention are preferably applied pre-emergently, i. e. before the undesired plants emerge. Pre-emergent application in crops may be carried out shortly before or shortly after the crop has been planted but preferably before the crop plants emerge.

The formulation of the invention and the combinations of the invention can be applied in crops which have been modified by mutagenesis or genetic engineering in order to provide a new trait to a plant or to modify an already present trait. Mutagenesis includes techniques of random mutagenesis using X-rays or mutagenic chemicals, but also techniques of targeted mutagenesis, in order to create mutations at a specific locus of a plant genome. Targeted mutagenesis techniques frequently use oligonucleotides or proteins like CRISPR/Cas, zinc-finger nucleases, TALENs or meganucleases to achieve the targeting effect. Genetic engineering usually uses recombinant DNA techniques to create modifications in a plant genome which under natural circumstances cannot readily be obtained by cross breeding, mutagenesis or natural recombination. Typically, one or more genes are integrated into the genome of a plant in order to add a trait or improve a trait. These integrated genes are also referred to as transgenes in the art, while plant comprising such transgenes are referred to as transgenic plants. The process of plant transformation usually produces several transformation events, which differ in the genomic locus in which a transgene has been integrated. Plants comprising a specific transgene on a specific genomic locus are usually described as comprising a specific “event”, which is referred to by a specific event name. Traits which have been introduced in plants or have been modified include in particular herbicide tolerance, insect resistance, increased yield and tolerance to abiotic conditions, like drought.

Examples of genetically modified crops in which the formulations and combinations can be used include in particular corn and soybean:

Transgenic soybean events comprising herbicide tolerance genes are for example, but not excluding others, GTS 40-3-2, MON87705, MON87708, MON87712, MON87769, MON89788, A2704-12, A2704-21, A5547-127, A5547-35, DP356043, DAS44406-6, DAS68416-4, DAS-81419-2, GU262, SYHTØH2, W62, W98, FG72 and CV127.

Transgenic cotton events comprising herbicide tolerance genes are for example, but not excluding others, 19-51a, 31707, 42317, 81910, 281-24-236, 3006-210-23, BXN10211, BXN10215, BXN10222, BXN10224, MON1445, MON1698, MON88701, MON88913, GHB119, GHB614, LLCotton25, T303-3 and T304-40.

In case the first and the second agricultural active compound are from the group of herbicides, the SC formulations and the combinations of the invention provide a very good control of vegetation during the fallow period, i. e. the period following harvest and before the following crop is planted.

In case the first and the second agricultural active compound are from the group of herbicides, the SC formulations of the invention provide a very good control of vegetation also in non-crop areas, especially at high application rates.

In case the SC formulations contain pyroxasulfone as the first agricultural compound and dicamba or a salt thereof as the second agricultural compound, the SC formulations and the combinations of the invention provide a very good control of the following plants, including broadleaf weeds, such as Amaranth, Palmer (Amaranthus palmeri), Amaranth, Powell (Amaranthus powellil), Bedstraw, catchweed (Galium aparine), Beggar ticks, hairy (Bidens pilosa), Beggarweed, Florida (Desmodium tortuosum), Bindweed, field (Convolvulus arvensis), Buckwheat, wild (Polygonum convolvulus), Buffalo bur (Solanum rostratum) C. Bur cucumber (Sicyos angulatus) S, Canola, volunteer (rapeseed), all types (Brassica spp.), Carpetweed (Mollugo verticillata), Chamomile, mayweed (Anthemis cotula), Chickweed, common (Stellaria media), Cocklebur, common (Xanthium strumarium), Copperleaf, Virginia (Acalypha virginica), Cotton, volunteer (Gossypium hirsutum), Cow cockle (Vaccaria pyramidata), Dandelion (Taraxacum officinale), Devil's-claw (Proboscidea louisiana), Eclipta (Eclipta prostrata), Evening primrose, cut leaf (Oenothera laciniata), Galinsoga, small flower (Galinsoga parviflora), False flax, small seed (Camelina macrocarpa), Filaree, redstem (Erodium cicutarium), Fleabane, hairy (Conyza bonariensis), Flixweed (Descurainia sophia), Groundcherry, cut leaf (Physalis angulate), Groundsel, common (Senecio vulgaris), Hawksbeard, narrowleaf (Crepis tectorum), Hemlock, poison (Conium maculatum), Henbit (Lamium amplexicaule), Horseweed (marestail) (Conyza canadensis), Jimsonweed (Datura stramonium), Knotweed, prostrate (Polygonum aviculare), Kochia (Kochia scoparia), Lady thumb (Polygonum persicaria), Lambsquarters, common (Chenopodium album), Lambsquarters, narrowleaf (Chenopodium pratericola), Lettuce, prickly (Lactuca serriola), Mallow, common (Malva neglecta), Mallow, little (cheese weed) (Malva parviflora), Mallow, Venice (Hibiscus trionum), Marestail (horseweed) (Conyza canadensis), Morning glory, entire leaf (Ipomoea hederacea var. integriuscula), Morning glory, ivy leaf (Ipomoea hederacea), Morning glory, palm leaf (Ipomoea wrightii), Morning glory, pitted (Ipomoea lacunose), Morning glory, tall (Ipomoea purpurea), Mustard, black (Brassica nigra), Mustard, tumble (Sisymbrium altissimum), Mustard, wild (Sinapis arvensis), Nettle, burning (Urtica urens), Nightshade, black (Solanum nigrum), Nightshade, cut leaf (Solanum triflorum), Nightshade, Eastern black (Solanum ptycanthum), Nightshade, hairy (Solanum sarrachoides), Parthenium (Parthenium hysterophorus), Pennycress, field (Thlaspi arvense), Pigweed, prostrate (Amaranthus blitoides), Pigweed, redroot (Amaranthus retroflexus), Pigweed, smooth (Amaranthus hybridus), Pigweed, tumble (Amaranthus albus), Puncturevine (Tribulus terrestris), Purslane, common (Portulaca oleracea), Pusley, Florida (Richardia scabra), Ragweed, common (Ambrosia artemisiifolia), Ragweed, giant (Ambrosia trifida), Rocket, London (Sisymbrium irio), Sesbania, hemp (Sesbania exaltata), Shepherds-purse (Capsella bursa-pastoris), Sida, prickly (Sida spinosa), Smartweed, Pennsylvania (Polygonum pensylvanicum), Sow thistle, annual (Sonchus arvensis), Spurge, nodding (Chamaesyce nutans), Spurge, spotted (Chamaesyce maculate), Starbur, bristly (Acanthospermum hispidum), Sunflower, common (Helianthus annuus), Tansy mustard, pinnate (Descurainia pinnata), Texas weed (Caperonia palustris), Thistle, Canada (Cirsium arvense), Thistle, Russian (Salsola kali), Velvetleaf (Abutilon theophrasti), Waterhemp (Amaranthus tuberculatus) and Willow weed (Epilobium adenocaulon);
Annual grass weeds, such as Barley, hare (Hordeum murinum spp. leporinum); Barnyardgrass (Echinochloa crus-galli), Bluegrass, annual (Poa annua), Bluegrass, rough stalk (Poa trivialis), Brome, California (Bromus carinatus), Brome, downy (Bromus tectorum), Brome, Japanese (Bromus japonicus), Canarygrass (Phalaris canariensis), Cheat (Bromus secalinus), Crabgrass, large (Digitaria sanguinalis), Crabgrass, smooth (Digitaria ischaemum), Crowfootgrass (Dactyloctenium aegyptium), Cup grass, Southwestern (Eriochloa gracilis), Cup grass, woolly (Eriochloa villosa), Fescue, rattail (Vulpia myuros), Foxtail, giant (Setaria faberi), Foxtail, green (Setaria viridis), Foxtail, yellow (Setaria pumila), Goosegrass (Eleusine indica), Johnsongrass (seedling) (Sorghum halepense), Millet, Texas (Urochloa texana), Millet, wild proso (Panicum miliaceum), Oat, wild (Avena fatua), Panicum, fall (Panicum dichotomiflorum), Panicum, Texas (Panicum texanum), Rice, red (Oryza sativa), Ryegrass, Italian (Lolium multiflorum), Ryegrass, rigid (Lolium rigidum), Sandbur (Cenchrus spp.), Shatter cane (Sorghum bicolor), Signal grass, broadleaf (Brachiaria platyphylla), Witchgrass (Panicum capillare), Flatsedge, rice (Cyperus iria) and Nutsedge, yellow (Cyperus esculentus).

The application of the formulation of the invention may vary depending on the rate may depend on the kind of ground to which the formulation is applied is typically in the range of 1 to 100 kg/h, in particular in the range of 5 to 50 kg/ha.

The individual application rates of pyroxasulfone is typically in the range of 5 to 250 g/ha, in particular in the range of 15 to 120 g/ha.

The individual application rates of dicamba is typically in the range of 50 to 1500 g/ha, in particular in the range of 120 to 1200 g/ha.

In case the first and the second agricultural active compound are from the group of herbicides, the SC formulations of the present invention may be applied preplant, preemergence, or as burndown application, in particular in the fall. Preplant application may be done to the surface or by incorporating the formulation or the individual herbicides of the combination into the ground.

Preplant surface application is typically carried out by applying a uniform broadcast to the soil surface. Preplant surface application is usually carried out within 30 days of planting and before crop emergence. For preplant incorporated (PPI) application the formulation or the individual herbicides of the combination are usually incorporated into the upper soil surface, e. g. into a depth of 2 to 6 cm, preferably within 14 days of planting. Incorporation may be carried out by shallow incorporation, including a field cultivator, harrow, rolling cultivator, or finishing disc.

The SC formulation is particularly advantageous with regard to minimizing off-target movement. Mitigation of off-target movement of pesticides from the treated area minimizes potential negative environmental effects and maximizes the efficacy of pesticide where it is most needed. By their nature, herbicides affect sensitive plants and mitigating their off-target movement reduces their effect on neighboring crops and other vegetation, while maximizing weed control in the treated field. Off-target movement can occur through a variety of mechanisms generally divided into primary loss (direct loss from the application equipment before reaching the intended target) and secondary loss (indirect loss from the treated plants and/or soil) categories. Primary loss from spray equipment typically occurs as fine dust or spray droplets that take longer to settle and can be more easily blown off-target by wind. Off-target movement of spray particles or droplets is typically referred to as ‘spray drift’. Primary loss can also include when contaminated equipment is used to make an inadvertent application to a sensitive crop. Contamination may occur when one product (i.e. pesticide) is not adequately cleaned from spray equipment and the contaminated equipment is later used to apply a different product to a sensitive crop resulting in crop injury. Secondary loss describes off-target movement of a pesticide after it contacts the target soil and/or foliage and moves from the treated surface by means including airborne dust (e.g. crystalline pesticide particles or pesticide bound to soil or plant particles), volatility (i.e. a change of state from the applied solid or liquid form to a gas), or run-off in rain or irrigation water. Off-target movement is typically mitigated by proper application technique (e.g. spray nozzle selection, nozzle height and wind limitations) and improved pesticide formulation. This is also the case for dicamba where proper application technique mitigates potential primary loss and equipment contamination. Secondary loss for dicamba has been further reduced through the development of formulations using improved dicamba salts such as the N,N-bis-(3-aminopropyl)methylammonium (“BAPMA”) salt of dicamba. The SC formulations have advantageous primary—and secondary loss profiles, are safe for the applicant, and have a high biological activity.

The following examples illustrate the invention.

### ABBREVIATIONS

BAPMA N,N-Bis-(3-aminopropyl)methylamine
EO ethylene oxide
HPMC hydroxypropylmethyl cellulose
PO propylene oxide
SC suspension concentrate
% w/w % by weight

### Materials Used:

Dispersant A: tristyrylphenol-polyoxyethylene phosphate, Soprophor® FLK, SOLVAY.
Dispersant B: high molecular weight alkylnaphthalene sulfonate condensate, Morwet® D809, NOURYON.
Dispersant C: mixture of the salts of naphthalene sulfonate condensate and phenol sulfonate condensate, Tamol® DN, BASF SE.
Dispersant D: EO/PO blockpolymer, Pluronic® PE 10500, BASF SE.
Surfactant: ethoxylated castor oil, Alkamuls® VO/2003, SOLVAY.
Antifoam 1: polydimethylsiloxane emulsion, SILFOAM® SRE, Wacker Chemie AG.
Antifoam 2: polydimethylsiloxane emulsion, Wacker Silicon SRE-PFL, Wacker Chemie AG.
HPMC: hydroxypropyl methylcellulose, methoxy groups content 19-24%, hydroxypropoxy groups content 7-22%, dynamic viscosity in water at 20 °C at a concentration of 2 wt % of 3500 to 5600 cP, Methocel® K4M, The DOW Chemical Company.
Methylcellulose: methoxy groups content 27 to 32 wt %, dynamic viscosity at 20 °C at a concentration of 2 wt % of 4000 cP Methocel® A4M, The DOW Chemical Company
Adjuvant A: non-ionic adjuvant composition comprising dimethylpolysiloxane, alkanolamides, fatty acids, and alkyl aryl polyoxylkane ethers.
Xanthan gum: xanthan gum, Rhodopol® G, Solvay S.A.
Biocide 1: a mixture of chloromethyl isothiazolinone and methyl isothiazolinone, Acticide® MV, Thor GmbH.
Biocide 2: glycol-based 2-bromo-2-nitro-1,3-propanediol solution, Acticide® L 30, Thor GmbH.
Biocide 3: glycol-based benzisothiazolinone solution, Acticide® B 20, Thor GmbH.
Dicamba-SL: 600 g/l solution of N,N-Bis-(3-aminopropyl)methylammonium salt of dicamba in water.

If not stated otherwise, viscosities of the SC formulations were measured at 20 °C at a shear rate of 100 s-1, using a HR-10 Discovery hybrid rheometer (TA waters).

If not stated otherwise, particle sizes were determined by static light scattering of a 10-20% w/w aqueous dilution of the SC formulation with a Malvern Mastersizer 3000.

If not stated otherwise, pH values were determined at 22 °C and 1 bar in the undiluted aqueous formulations by means of a glass electrode.

### EXAMPLE-1: MANUFACTURE OF SC FORMULATION

### Step A: Liquid SC Formulation

A liquid aqueous suspension with the ingredients according to Table 1 was generated. To this end, the ingredients were mixed until a homogenous composition was achieved, which was subsequently milled in a bead mill until a mean particle size (D50) of below 1.5 microns was obtained.

TABLE 1
ingredients of liquid SC formulation

| Ingredient | Concentration in wt % |
|---|---|
| Pyroxasulfone | 49.63 |
| Dispersant A | 4.54 |
| Dispersant B | 4.54 |
| Glycerol | 18.16 |
| Antifoam 1 | 0.41 |
| Biocide | 2.92 |
| Xanthan gum | 0.08 |
| Water | to 100 |

### Step B: Liquid Agrochemical Solution

Water, the BAPMA salt of dicamba, and potassium carbonate and optionally potassium citrate (tribasic, monohydrate) were mixed until a uniform solution with a concentration of 754 g/l of the salt was obtained.

### Step C:

The SC formulation of Step A and the agrochemical solution of Step B were mixed with biocides, Antifoam 1 and optionally further ingredients and/or methylated soybean oil. Guar gum and the cellulose-based thickener were activated by addition of water and incubation at room temperature for approximately 20 minutes. Subsequently, the liquid agrochemical composition and the activated thickeners were mixed until uniform, and the resulting mixture was sieved through a 150 μm sieve to obtain the homogenous SC formulations SC-1 to SC-7 with the ingredients as summarized in Table 2

TABLE 2
ingredients of final liquid SC formulations SC-1 to SC-7

| | Concentration in g/l | | | | | | |
|---|---|---|---|---|---|---|---|
| Ingredients | SC-1 | SC-2 | SC-3 | SC-4 | SC-5 | SC-6 | SC-7 |
| Pyroxasulfone | 91.4 | 91.4 | 91.4 | 91.4 | 91.4 | 91.4 | 103 |
| Dicamba BAPMA | 537 | 537 | 537 | 537 | 537 | 537 | 603 |
| K₂CO₃ | 143 | 110 | 143 | 143 | 8.40 | 143 | — |
| Potassium citrate, | — | 33 | — | — | 2.52 | — | — |
| tribasic, monohydrate | | | | | | | |
| Dispersant A | 8.36 | 8.36 | 8.36 | 8.36 | 8.36 | 8.36 | 9.42 |
| Dispersant B | 8.36 | 8.36 | 8.36 | 8.36 | 8.36 | 8.36 | 9.42 |
| Surfactant | — | — | — | 20 | — | | — |
| Glycerol | 33.44 | 33.44 | 33.44 | 33.44 | 33.44 | 33.44 | 37.68 |
| Antifoam 1 | 3.0 | 3.0 | 3.0 | 3.0 | 3.0 | 3.0 | 5.0 |
| Biocide 1 | 1.42 | 1.42 | 1.42 | 1.42 | 1.42 | 1.42 | 1.42 |
| Biocide 2 | 1.14 | 1.14 | 1.14 | 1.14 | 1.14 | 1.14 | 1.14 |
| Biocide 3 | 2.83 | 2.83 | 2.83 | 2.83 | 2.83 | 2.83 | 2.83 |
| Xanthan gum | 0.15 | 0.15 | 0.15 | 0.15 | 0.15 | 0.15 | 0.17 |
| HPMC | 2.5 | 2.5 | — | — | — | 2.5 | 5.0 |
| Methylcellulose | — | — | 5.0 | 3.0 | 5.0 | — | — |
| Guar gum | 0.5 | 0.5 | 0.5 | 0.25 | 0.5 | 0.5 | 1.0 |
| Methylated | — | — | — | 40 | — | — | — |
| soybean oil | | | | | | | |
| Water | to 1 L | to 1 L | to 1 L | to 1 L | to 1 L | to 1 L | to 1 L |
| Density [g/ml] | 1.31 | 1.31 | 1.32 | 1.31 | 1.31 | 1.31 | 1.24 |

### EXAMPLE 2: TEMPERATURE STABILITY OF SC FORMULATION

Samples of SC-1 were assessed on their storage stability by incubation for two weeks at 54 °C. The samples stayed homogenous without sedimentation or serum formation.

### EXAMPLE 3: PARTICLE SIZE MEASUREMENT

Samples of SC-1 were incubated at various temperatures and time periods, wherein the particle sizes (D50 and D90) were measured as indicated in Table 3.

TABLE 3
storage conditions and particle size measurement of SC-1

| | | Two weeks | Four weeks | Eight weeks |
|---|---|---|---|---|
| | Initial without | storage at | storage at | storage at |
| | storage | 54 °C | 40 °C | 40 °C |
| D50 | 1.46 | 1.53 | 1.53 | 1.49 |
| D90 | 4.03 | 3.88 | 3.88 | 4.5 |

### EXAMPLE 4: SPRAYING PROPERTIES

The fine droplet ratio properties of the diluted soluble concentrates SC-3 to SC-5 in admixture to glyphosate were analyzed. To this end, 0.93 L of a suspension SC-3 to SC-5 was mixed with 2.07 L of a soluble concentrate comprising 540 g/l of the potassium salt of glyphosate, which mixture was diluted with water to a total volume of 94 L. The resulting spray solution was then sprayed either with an AIXR 110 04 nozzle (“Air Induction XR Flat Spray Tip”) with a pressure of 2.76 bar or a TTI 110 03 nozzle (“Turbo TeeJet Induction Flat Spray Tip”) at a pressure of 4.8 bar. The droplet size distribution was measured with a Sympatec Helos KF Laser diffraction device. Measurement was in 31 particle size classes from 18 to 3500 μm. Measurement was made at a distance of 30.5 cm from the nozzle. The analysis of data was based on 10 measurements collected in two runs. If necessary, the lenses were cleaned in-between.

For comparison, a spray solution was prepared by mixing 0.93 L of an aqueous soluble concentrate containing 754 g/L dicamba N,N-bis-(3-aminopropyl)methylammonium (SL-C1) with 2.07 L of a soluble concentrate comprising 540 g/L of the potassium salt of glyphosate and diluted with water to a total volume of 94 L. Table 4 shows the fractions of fine droplets for the different nozzle types and the tested suspensions SC-3 to SC-5 in comparison with SL-C1.

TABLE 4
measurement of fine droplets ratios <100 μm
of SC-3, SC-4, and SL-1 after admixture to glyphosate
potassium salt and dilution with water

| | Fine droplets with mean | Fine droplets with mean |
|---|---|---|
| Soluble | diameter below 100 μm | diameter below 100 μm |
| concentrate | by spraying with AIXR | by spraying with TTI |
| tested | nozzle in [%]. | nozzle in [%]. |
| SC-3 | 7.9 | 1.3 |
| SC-4 | 8.1 | 1.2 |
| SC-5 | 9.2 | 1.5 |
| SL-C1 | 10.4 | 2.1 |
| SC-6 | not measured | not measured |
| SC-7 | not measured | not measured |

### EXAMPLE 5

Suspensions SC-1 to SC-3 were analyzed for their volatility in the presence of the potassium salt of glyphosate. To this end, 0.93 L of a suspension SC-1 to SC-3 was mixed with 2.07 L of a soluble concentrate comprising 540 g/l of the potassium salt of glyphosate, which mixture was diluted with water to a total volume of 94 L. Samples were further diluted with water to ensure similar amounts of active compounds per area in the test tubes as obtained by spraying the active compounds at the recommended application rates in the field. The samples were then incubated in glass tubes that were contained in water baths. The samples were incubated for 24 hours at 70 °C. Volatilized sample material was constantly removed from the tubes by an air conduct. Residual amounts of dicamba are determined relative to the applied amount. The reported volatility is [1−(residual amount/applied amount)] in percent. The results are summarized in Table 5 below.

TABLE 5
Volatility measured in a Büchi
Multivapor P-12 for samples SC-1 to SC-3

| Sample | SC-1 | SC-2 | SC-3 | SC-6 | SC-7 |
|---|---|---|---|---|---|
| Volatility [%] | 5.7 | 6.3 | 5.3 | 5.7 | not measured |

### EXAMPLE 6

Suspensions SC-3 to SC-5 were analyzed for their volatility in the presence of the potassium salt of glyphosate as described in Example 6. The results are summarized in Table 6 below.

TABLE 6
Volatility measured in a Büchi
Multivapor P-12 for samples SC-3 to SC-5

| Sample | SC-3 | SC-4 | SC-5 | SC-6 | SC-7 |
|---|---|---|---|---|---|
| Volatility [%] | 3.2 | 4.6 | 3.1 | 3.2 | not measured |

### EXAMPLE 7

A quantitative Humi-Dome study was carried out. To this end, two treated glass plates were placed in a plastic tray, which was covered with a clear plastic Humi-Dome (overall size 25 cm wide×50 cm long×20 cm tall by Hummert International). The Humi-Dome was fitted with an air sampling filter cassette containing fiberglass and cotton pad filter media, which was connected to a vacuum pump with a flow rate of 2 liters per minute. Individual Humi-Domes representing different study treatments and replicates were placed in a controlled growth chamber environment of 35 °C and 25 to 40% humidity. Suspensions SC-1 to SC-4 were tested in tank-mixes with water, 0.25 vol-% of Adjuvant A and the glyphosate-containing product Roundup PowerMAX II (1120 grams of acid equivalent per hectare).

Treatments were applied to the glass plates using a laboratory track sprayer using a TeeJet 95015E nozzle by Spraying Systems and a 146 L/ha spray volume. The application rate of dicamba was 560 grams of acid equivalent per hectare. After 24 hours of air sampling, filters were collected, extracted and analyzed for dicamba content using gas-chromatography coupled mass spectrometry. The total amount of dicamba captured was then divided by total volume of the air flow through the filter to calculate the total amount dicamba captured/unit volume of air as summarized in Table 7.

TABLE 7
reduction of dicamba captured in filter
as measured in Humi-Dome assay.

| Soluble | Reduction of dicamba captured |
|---|---|
| concentrate | in filter [ng/m³] |
| SC-3 | 32 |
| SC-4 | 33 |
| SC-5 | 39 |
| SC-6 | not measured |
| SC-7 | not measured |

### EXAMPLE 8

Lab trials were conducted to evaluate the ease of dicamba cleanout applied via SC-3 to SC-5. To this end, SC-3 to SC-5 were each mixed with the glyphosate-containing product Roundup Power MAX II in a ratio of 1:2 (v/v) and the mixtures were allowed to incubate overnight in 11″ EPDM hose sections. Next day, the hose sections were first rinsed with water and then with pure methanol. The methanol rinse was collected for dicamba analysis using HPLC. Results showed that dicamba concentration in methanol rinse was 1.6-1.9 ppm in SC-3, SC-4, or SC-5 treatments.

### EXAMPLE 9: INFLUENCE OF THICKENER COMBINATION

A suspension of pyroxasulfone was produced analogously to Step A of Example 1, a solution of dicamba-BAPMA was provided analogously to Step B of Example 1 and both mixtures were combined analogously to Step C of Example 1. The final constituents and amounts are indicated in Table 8 below. The stability of suspension is also indicated in Table 8. Run 1 is carried out according to the present invention, Runs 2-4 are comparative examples.

TABLE 8
Long term stability of SC formulations at elevated temperatures.

| Ingredients | Run 1 | Run 2 | Run 3 | Run 4 |
|---|---|---|---|---|
| [g/l] | (inv.) | (comp.) | (comp.) | (comp.) |
| DICAMBA | 427 | 427 | 427 | 427 |
| BAPMA | 109.6 | 109.6 | 109.6 | 109.6 |
| Pyroxasulfone | 91.4 | 91.4 | 91.4 | 91.4 |
| Dispersant A | 8.36 | 8.36 | 8.36 | 8.36 |
| Dispersant B | 8.36 | 8.36 | 8.36 | 8.36 |
| Antifoam 1 | 3.0 | 3.0 | 3.0 | 3.0 |
| Glycerol | 33.44 | 33.44 | 33.44 | 33.44 |
| HPMC | 2.5 | 0 | 2.5 | 0 |
| Xanthan Gum | 0.15 | 0.15 | 0.15 | 0.15 |
| Guar Gum | 0.5 | 0 | 0 | 0.5 |
| Biocide 1 | 1.42 | 1.42 | 1.42 | 1.42 |
| Biocide 2 | 1.14 | 1.14 | 1.14 | 1.14 |
| Biocide 3 | 2.83 | 2.83 | 2.83 | 2.83 |
| K₂CO₃ | 143 | 143 | 143 | 143 |
| Water | ad 1 L | ad 1 L | ad 1 L | ad 1 L |
| Initial | homoge- | serum on | homoge- | inhomoge- |
| Properties | neous | top | neous | neous |
| Properties after | light phase | 37% | 4% serum on | 33% serum |
| 14 d 54 °C ¹⁾ | separation | serum | top, phase | on bottom |
| | | on top | separation | |
| Properties after | 2% | 49% | 3% serum, | 40% serum |
| 4 w/40 °C ²⁾ | serum, | serum, | light | bottom, |
| | light | light | sediment, | inhomoge- |
| | sediment | sediment | light phase | neous |
| | | | separation | |
| Properties after | 3% | 44% | 5% serum, | 43% serum |
| 8 w/40 °C ³⁾ | serum, | serum, | light | bottom, |
| | light | light | sediment, | inhomoge- |
| | sediment | sediment | phase | neous |
| | | | separation | |
| | | | (40/60) | |
| Initial Viscosity | 260 | 71 | 201 | 126 |
| [mPa · s] | | | | |
| Viscosity after | 228 | 74 | 184 | 127 |
| 14 d/54 °C ¹⁾ | | | | |
| Viscosity after | 225 | 70 | 189 | 116 |
| 4 w/40 °C ²⁾ | | | | |
| Viscosity after | 247 | 72 | 187 | 120 |
| 8 w/40 °C ³⁾ | | | | |

¹⁾ storage for 14 days at 54 °C
²⁾ storage for 4 weeks at 40 °C
³⁾ storage for 8 weeks at 40 °C

The results of Table 8 show that long term stability of SC formulations at elevated temperatures can be achieved when using a combination of xanthan gum, guar gum, and a cellulose-based thickener.

### EXAMPLE 10: INFLUENCE OF DIFFERENT THICKENER COMBINATIONS

Example 9 was repeated with different percentages of the thickener composition. Run 1 is carried out according to the present invention, Runs 2-8 are comparative examples. The final compositions and results are shown in Table 9 herein below.

Table 9 indicates that an increase in concentration of one or two thickeners alone is less effective in stabilizing the SC formulation than the simultaneous presence of all three thickeners.

TABLE 9
Long term stability of SC formulations at elevated temperatures

| | Run 1 | Run 2 | Run 3 | Run 4 |
|---|---|---|---|---|
| Ingredients | (inv.) | (comp.) | (comp.) | (comp.) |
| Dicamba [g/L] | 427 | 427 | 427 | 427 |
| BAPMA [g/L] | 109.6 | 109.6 | 109.6 | 109.6 |
| Pyroxasulfone [g/L] | 91.4 | 91.4 | 91.4 | 91.4 |
| Dispersant A [g/L] | 8.36 | 8.36 | 8.36 | 8.36 |
| Dispersant B [g/L] | 8.36 | 8.36 | 8.36 | 8.36 |
| Antifoam 1 [g/L] | 3.0 | 3.0 | 3.0 | 3.0 |
| Glycerol [g/L] | 33.44 | 33.44 | 33.44 | 33.44 |
| HPMC [g/L] | 2.5 | 0 | 3 | 0 |
| Xanthan gum [g/L] | 0.15 | 0.15 + 0.5 | 0 | 0 |
| Guar Gum [g/L] | 0.5 | 0 | 0 | 1.5 |
| Biocide 1 [g/L] | 1.42 | 1.42 | 1.42 | 1.42 |
| Biocide 2 [g/L] | 1.14 | 1.14 | 1.14 | 1.14 |
| Biocide 3 [g/L] | 2.83 | 2.83 | 2.83 | 2.83 |
| K₂CO₃ [g/L] | 143 | 143 | 143 | 143 |
| Water [g/L] | ad 1 L | ad 1 L | ad 1 L | ad 1 L |
| Density [g/ml] | | | | |
| Visual Examination: | homogeneous | homogeneous | homogeneous | homogeneous |
| initial | | | | |
| Examination after | unchanged | slight serum, | 2% serum, | slight serum, |
| 14 d/RT ¹⁾ | | gel-like, | inhomogeneous | reversible |
| | | solid, not | reversible | |
| | | reversible | | |
| Examination after | slight | 17% serum, | 6% serum, 4% | 10% serum, |
| 14 d/54 °C ²⁾ | phase | gel-like, | serum bottom, | reversible |
| | separation, | solid, not | reversible | |
| | reversible | reversible | | |
| Examination after | 0% Serum, | 14% serum, | 4% serum, | 8% Serum, |
| 4 w/40 °C ³⁾ | light | gel-like, | 4% serum | inhomogeneous, |
| | sediment | solid, not | bottom, | reversible |
| | | reversible | reversible | |
| Initial viscosity | 214 | 253 | 194 | 227 |
| [mPa · s] | | | | |
| 14 d/54 °C ²⁾ | 245 | solid | 196 | 280 |
| 4 w/40 °C ³⁾ | 250 | solid | 213 | 270 |

| | Run 5 | Run 6 | Run 7 |
|---|---|---|---|
| Ingredients | (comp.) | (comp.) | (comp.) |
| Dicamba [g/L] | 427 | 427 | 427 |
| BAPMA [g/L] | 109.6 | 109.6 | 109.6 |
| Pyroxasulfone [g/L] | 91.4 | 91.4 | 91.4 |
| Dispersant A [g/L] | 8.36 | 8.36 | 8.36 |
| Dispersant B [g/L] | 8.36 | 8.36 | 8.36 |
| Antifoam 1 [g/L] | 3.0 | 3.0 | 3.0 |
| Glycerol [g/L] | 33.44 | 33.44 | 33.44 |
| HPMC [g/L] | 2.5 | 0 | 3 |
| Xanthan gum [g/L] | 0.15 | 0.15 + 0.45 | 0 |
| Guar Gum [g/L] | 0 | 2 | 0.6 |
| Biocide 1 [g/L] | 1.42 | 1.42 | 1.42 |
| Biocide 2 [g/L] | 1.14 | 1.14 | 1.14 |
| Biocide 3 [g/L] | 2.83 | 2.83 | 2.83 |
| K₂CO₃ [g/L] | 143 | 143 | 143 |
| Water [g/L] | ad 1 L | ad 1 L | ad 1 L |
| Density [g/ml] | | | |
| Visual Examination: | homoge- | homoge- | homoge- |
| initial | neous | neous | neous |
| Examination after | 4% serum, | slight serum, | unchanged |
| 14 d/RT ¹⁾ | reversible | reversible | |
| Examination after | 54% serum | 8% serum, | 8% serum, |
| 14 d/54 °C ²⁾ | (phase | inhomoge- | reversible |
| | separation?), | neous, | |
| | reversible | reversible | |
| Examination after | 42% serum | 10% serum, | light serum, |
| 4 w/40 °C ³⁾ | (phase | inhomogeneous, | light |
| | separation?), | reversible | sediment, |
| | reversible | | reversible |
| Initial viscosity | 233 | 242 | 237 |
| [mPa · s] | | | |
| 14 d/54 °C ²⁾ | 189 | 289 | 239 |
| 4 w/40 °C ³⁾ | 196 | 284 | 241 |

### EXAMPLE 11: MANUFACTURE OF SC FORMULATION CONTAINING PYROXASULFONE AND IMAZETHAPYR

### Step A: Liquid SC Formulation

A liquid aqueous suspension with the ingredients according to Table 10 was generated. To this end, the ingredients were mixed until a homogenous composition was achieved, which was subsequently milled in a bead mill until a mean particle size (050) of below 1.5 microns was obtained.

TABLE 10
ingredients of liquid SC formulation

| Ingredient | Concentration in wt % |
|---|---|
| Pyroxasulfone | 41.46 |
| Dispersant C | 1.66 |
| Dispersant D | 2.49 |
| 1,2-Propylene glycol | 5.8 |
| Antifoam 2 | 0.41 |
| Biocide 1 | 0.1 |
| Biocide 2 | 0.08 |
| Biocide 3 | 0.19 |
| Xanthan gum | 0.17 |
| Water | to 100 |

### Step B: Liquid Agrochemical Solution PGP-3027.

Water, the potassium salt of imazethapyr, and an aqueous solution of potassium hydroxide were mixed until a uniform solution with a concentration of 35 wt % of the salt was obtained.

### Step C:

The SC formulation of Step A and the agrochemical solution of Step B were mixed with biocides and Antifoam 2. Guar gum and HPMC were activated by addition of water and incubation at room temperature for approximately 20 minutes. Subsequently, the liquid agrochemical composition and the activated thickeners were mixed until uniform, and the resulting mixture was sieved through a 150 μm sieve to obtain the homogenous SC formulations SC-8 with the ingredients as summarized in Table 11.

TABLE 11
ingredients of final liquid SC formulation SC-8

| Ingredients [g/L] | Concentration in g/l |
|---|---|
| Pyroxasulfone | 273.5 |
| Imazethapyr, potassium salt | 159.5 |
| 1,2-Propanediol | 38.29 |
| Antifoam 2 | 3.0 |
| Dispersant C | 10.94 |
| Dispersant D | 16.41 |
| Biocide 1 | 1.0 |
| Biocide 2 | 0.8 |
| Biocide 3 | 2.0 |
| Aqueous KOH solution (50 wt. %) | 61.89 |
| Xanthan gum | 3.0 |
| HPMC | 2.5 |
| Guar gum | 0.5 |
| Water | to 1 L |
| Density [g/ml] | 1.161 |

The storage stability of formulation SC-8 was examined by incubating samples of the formulations at various temperatures for different periods of time. The samples were then visually assessed, their viscosities and pH values were measured and the sizes of the particles contained in the samples were analyzed. The results are shown in Table 12.

TABLE 12
Evaluation of SC-8 samples after different storage conditions

| | | Two weeks | Four weeks | Eight weeks |
|---|---|---|---|---|
| | | storage | storage | storage |
| | | at 54 °C | at 40 °C | at 40 °C |
| | | 0% serum¹⁾, | 0% serum¹⁾, | 0% serum¹⁾, |
| | Initial | homoge- | homoge- | homoge- |
| | without | neous, no | neous, no | neous, no |
| Visual | storage | sediment, | sediment, | sediment, |
| assessment | unchanged | reversible²⁾ | reversible²⁾ | reversible²⁾ |
| pH value | 7.37 | 6.85 | 6.82 | 6.76 |
| Viscosity | 208 | 203 | 173 | 167 |
| Proportion of | 78.53 | 70.16 | 73.96 | 71.98 |
| particles <2 μm | | | | |
| [vol %] | | | | |
| D50 | 1.11 | 1.44 | 1.34 | 1.40 |
| D90 | 3.94 | 3.84 | 3.22 | 3.30 |

¹⁾no upper phase separation;
²⁾liquid and homogenous after shaking.

As apparent from the visual assessments summarized in Table 12, under all conditions analyzed the formulation SC-8 remained homogeneous and, especially, no phase separation and no sedimentation occurred. In addition, the values given in Table 12 for the pH values, viscosities and the particle sizes confirm that the formulation SC-8 remained fairly stable under the different storage conditions.

A further sample of the formulation SC-8 was stored for four weeks at a temperature of −20 °C. Under these conditions, the sample became solid but returned to its original state after one hour at room temperature.

1. An aqueous agrochemical suspension concentrate formulation comprising
a) 1 to 40 wt %, based on a total weight of the formulation, of at least one first agrochemical active compound in a form of particles suspended in an aqueous phase;
b) 5 to 75 wt %, based on the total weight of the formulation, of at least one second agrochemical active compound which is dissolved in the aqueous phase;
c) a thickener system comprising
c.1) xanthan gum,
c.2) guar gum, and
c.3) a cellulose-based thickener,
d) an aqueous phase comprising water.

2. The formulation of claim 1, wherein the first agrochemical active compound is pyroxasulfone.

3. The formulation of claim 1, wherein the at least one second agrochemical active compound is selected from the group consisting of a salt of dicamba, a salt of glufosinate, a salt of glyphosate and a salt of imidazolinone herbicides.

4. The formulation of claim 3, where the second agrochemical active compound is the salt of dicamba.

5. The formulation of claim 1, wherein a concentration of the first agrochemical active compound is in a range of 7 to 28 wt % and a concentration of the second agrochemical active compound is in a range of 15 to 60 wt %, based on the total weight of the agrochemical suspension concentrate.

6. The formulation of claim 1, wherein the cellulose-based thickener is selected from the group consisting of methylcellulose and hydroxypropyl methylcellulose.

7. The formulation of claim 6, wherein the hydroxypropyl methylcellulose contains 15 to 35 wt % of methoxy groups, based on a total weight of the hydroxypropyl methylcellulose and wherein the hydroxypropyl methylcellulose contains 5 to 15 wt % hydroxypropoxy groups, based on the total weight of the hydroxypropyl methylcellulose.

8. The formulation of claim 1, wherein a weight ratio of the cellulose-based thickener to the guar gum is from 2:1 to 10:1, wherein a weight ratio of the guar gum to the xanthan gum is from 1:1 to 20:1, and wherein a concentration of the thickener system is in a range of 0.1 to 10 g/l.

9. The formulation of claim 1, further comprising at least one anionic dispersant F which bears at least one anionic group selected from sulfonate, sulfate, phosphonate, and phosphate groups,

10. The formulation of claim 1, further comprising at least one buffer, which is in particular selected from alkali metal carbonates and alkali metal citrates.

11. The formulation of claim 10, wherein a concentration of the buffer is in a range of 5 to 30 wt %, based on the total weight of the agrochemical suspension concentrate.

12. The formulation of claim 1, having at least one of the following features 12.1 to 12.3:
12.1 the at least one first agrochemical active compound has a water-solubility in deionized water at 20 °C, 1 bar and pH 7 of less than 2 g/l;
12.2 the suspended particles of the first agrochemical active compound have a D50 value, as measured by dynamic light scattering, in the range of 0.1 to 30 μm;
12.3 the concentration of water is from 10 to 60 wt %, based on the total weight of the agrochemical suspension concentrate.

13. A method for preparing the agrochemical suspension concentrate formulation as defined in claim 1 comprising
A) providing an aqueous suspension comprising suspended particles of the at least one first agrochemical active and a portion of the thickener system;
B) providing a liquid aqueous solution comprising the at least one second agrochemical active compound;
C) providing a remainder of the thickener system;
D) mixing the suspension provided in step A), the solution provided in step B) and the remainder of the thickener system in any given order.

14. (canceled)

15. A method of controlling undesired vegetation and/or plant pathogenic organisms, and/or for regulating the growth of plants, wherein the aqueous agrochemical suspension concentrate formulation as defined in claim 1 is allowed to act on the undesired vegetation and/or plant pathogenic organism, their environment, the crop plants to be protected from the undesired vegetation and/or plant pathogenic organism, the plant propagation material of the crop plants, and/or the environment of crop plants.

16. A method for treating plant propagation material comprising the treatment of the plant propagation material with the aqueous agrochemical suspension concentrate formulation as defined in claim 1.

17. A method for stabilizing an aqueous an aqueous agrochemical suspension concentrate formulation comprising at least one first agrochemical active compound in the form of particles suspended in an aqueous phase and at least one second agrochemical active compound which is dissolved in the aqueous phase comprising the use of a thickener system comprising.
c.1) xanthan gum,
c.2) guar gum, and
c.3) a cellulose-based thickener.

18. The formulation of claim 3 wherein the salt of dicamba is an ammonium salt of dicamba.

19. The formulation of claim 6 wherein the cellulose-based thickener is hydroxypropyl methylcellulose.
